(19) United States
(12) Patent Application Publication
(10) Pub. No.: US 2026/0302086 A1
(43) Pub. Date: Oct. 1, 2026

(54) CAPACITOR ASSEMBLY WITH A FIRST TO FOURTH INDIVIDUAL CAPACITOR ARRANGED IN A ROW

(71) Applicant: Semikron Danfoss Elektronik GmbH & Co. KG, Nuürnberg (DE)

(72) Inventors: Sandro BULOVIC, Langenzenn (DE); Johannes KLIER, Amberg (DE)

(21) Appl. No.: 19/630,876

(22) Filed: Mar. 27, 2026

(30) Foreign Application Priority Data
Apr. 1, 2025 (DE) 102025112703.4

(51) Int. Cl. H01G 4/38

(52) U.S. Cl. CPC H01G 4/38

(57) ABSTRACT

A capacitor assembly is presented with a first to fourth individual capacitor, each with a first cover surface defining a respective normal direction of the individual capacitor, and a second cover surface situated opposite, wherein the first cover surface of the first individual capacitor defines a main direction, with in each case first connection elements arranged on the first cover surface and in each case second connection elements arranged on the second cover surface, wherein the individual capacitors are arranged next to one another in a 1×4 matrix, wherein the normals of the first and third individual capacitors point in the main direction and wherein the normals of the second and fourth individual capacitors point in the opposite direction to the main direction and wherein all the first connection elements are connected to one another by means of a first busbar and wherein all the second connection elements are connected to one another by means of a second busbar.

### CROSS-REFERENCE TO RELATED APPLICATION

This application claims foreign priority benefits under 35 U.S.C. § 119 to German Patent Application No. 102025112703.4 filed on Apr. 1, 2025, the content of which is hereby incorporated by reference in its entirety.

### TECHNICAL FIELD

The invention describes a capacitor assembly with a first to fourth individual capacitor, each with a first cover surface defining a respective normal direction of the individual capacitor, and a second cover surface situated opposite, wherein the first cover surface of the first individual capacitor defines a main direction, with in each case first connection elements arranged on the first cover surface and in each case second connection elements arranged on the second cover surface, wherein the individual capacitors are arranged next to one another in a 1×4 matrix.

### BACKGROUND

DE 10 2019 134 650 A1 discloses a power electronics system with a housing, with a cooling device, with a power semiconductor module and with a capacitor device, wherein a cooling section of a capacitor connection device is in thermally conductive contact with a cooling surface of the cooling device.

DE 10 2012 215 787 A1 discloses a power electronics system with a multi-part housing, a plurality of power electronics switching devices, a capacitor device and a liquid cooling device. The multi-part housing here consists of three housing elements which have a cuboid basic shape, a central element and an upper and lower cover element arranged on opposite connection surfaces of the central element, wherein the housing has an inflow connection and an outflow connection for a cooling liquid, and at least one cooling chamber is formed between the central element and the upper cover element and at least two lower cooling chambers are formed between the central element and the lower cover element, wherein each cooling chamber has at least one cooling surface and wherein cooling liquid entering through the inflow connection and leaving at the outflow connection can flow through the cooling chambers which thus form the liquid cooling device.

### SUMMARY

The object of the invention is to improve the arrangement of capacitors of a capacitor assembly for a power electronics system.

This object is achieved according to the invention by a capacitor assembly with a first to fourth individual capacitor, each with a first cover surface defining a respective normal direction of the individual capacitor, and a second cover surface situated opposite, wherein the first cover surface of the first individual capacitor defines a main direction, with in each case first connection elements arranged on the first cover surface and in each case second connection elements arranged on the second cover surface, wherein the individual capacitors are arranged next to one another in a 1×4 matrix, wherein the normals of the first and third individual capacitors point in the main direction and wherein the normals of the second and fourth individual capacitors point in the opposite direction to the main direction and wherein all the first connection elements are connected to one another by means of a first busbar and wherein all the second connection elements are connected to one another by means of a second busbar.

The term arranged next to one another is intended in particular to be understood to mean that the cover surfaces of adjacent individual capacitors form, from a mathematical point of view and within what is technically feasible, subsurfaces of a plane. It goes without saying that the arrangement in a 1×4 matrix also includes embodiments in a 1×(2+2n) matrix as long as the configuration according to the invention is suitable for 4 of the 2+2n capacitors.

It can be advantageous if the individual capacitors are arranged in the sequence of a first, second, third and fourth individual capacitor or in the sequence of a first, second, fourth and third individual capacitor.

It can also be advantageous if the in each case first connection elements of all the individual capacitors are arranged in a first surface section of the first cover surface, and the in each case second connection elements of all the individual capacitors are arranged in a second surface section of the second cover surface. It is preferred here if in each case the first surface section and second surface section of an individual capacitor are arranged symmetrically with respect to each other. It is particularly preferred here if the symmetry is point symmetry with respect to the centre point of the individual capacitor or mirror symmetry with respect to a cut surface of the individual capacitor.

It can in principle be advantageous if the first and second busbars are formed as flat metal mouldings. It is here furthermore advantageous if the first and second busbars are arranged so that they overlap each other in sections and are separated by a first insulating device.

It can likewise be advantageous if a first intermediate section of the first busbar and a first intermediate section of the second busbar are arranged between the first and second individual capacitors, and a second intermediate section of the first busbar and a second intermediate section of the second busbar are arranged between the third and fourth individual capacitors so that they overlap each other and are in each case separated by a second insulating device.

It can also be preferred if the first busbar has an additional first connection section and the second busbar has an additional second connection section which are are arranged so that they overlap each other in one section and these connection sections are designed to simultaneously supply energy to all the individual capacitors.

It can be advantageous if the first busbar has additional first module sections and the second busbar has additional second module sections and these module sections are designed to simultaneously supply energy to the power semiconductor modules from the individual capacitors.

Lastly, it can be advantageous if the respective contact sections of the busbars with the associated connection elements of the individual capacitors are materially bonded, preferably welded, to one another.

The features or groups of features which are respectively referred to in the singular can of course be present multiple times in the capacitor assemblies according to the invention, unless this is explicitly precluded or precluded per se or is inconsistent with the concept of the invention.

It goes without saying that the features and configurations of the capacitor assembly mentioned above and below can be realized individually or in any desired combinations in order to achieve improvements. In particular, the features mentioned above or explained here or below can be used not only in the specified combinations but also in other non-exclusive combinations or alone without departing from the scope of the present invention.

### BRIEF DESCRIPTION OF THE DRAWINGS

Further explanations of the invention, advantageous details and features can be found in the following description of the exemplary embodiments of the invention illustrated schematically in FIGS. 1 to 7, or respective parts thereof.

FIG. 1 shows a schematic illustration of a power electronics system with a capacitor assembly according to the invention in an exploded view.

FIG. 2 shows a side view of a first embodiment of a capacitor assembly according to the invention.

FIG. 3 shows a side view of a second embodiment of a capacitor assembly according to the invention.

FIGS. 4 and 5 show the busbars of a first embodiment of a capacitor assembly according to the invention.

FIG. 6 shows a three-dimensional view of a second embodiment of a capacitor assembly according to the invention.

FIG. 7 shows an individual capacitor of a capacitor assembly.

### DETAILED DESCRIPTION

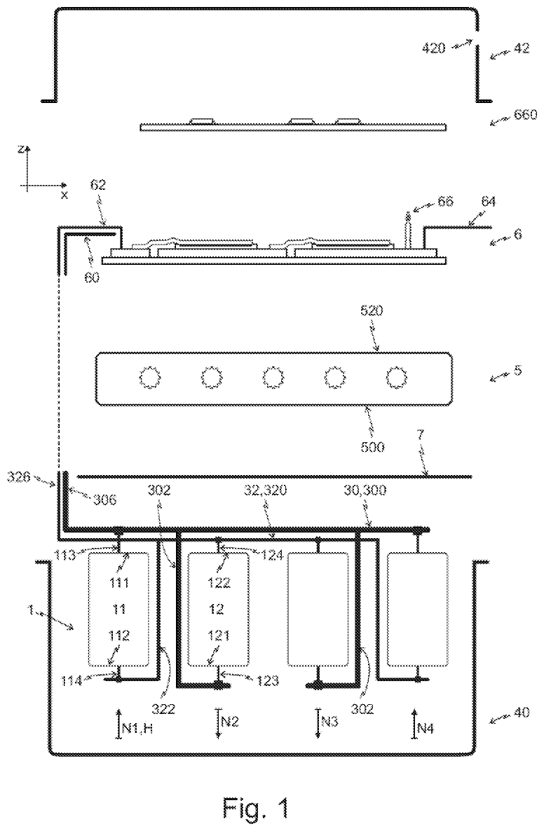

FIG. 1 shows a schematic illustration of a power electronics system with a capacitor assembly according to the invention in an exploded view. This system has, viewed from bottom to top, an arrangement, stacked in the main direction H, with a trough-shaped first housing part 40, the capacitor assembly 1, a cooling device 5, an insulating layer 7, a power semiconductor module 6, a control switching device 660 and with a second housing part 42.

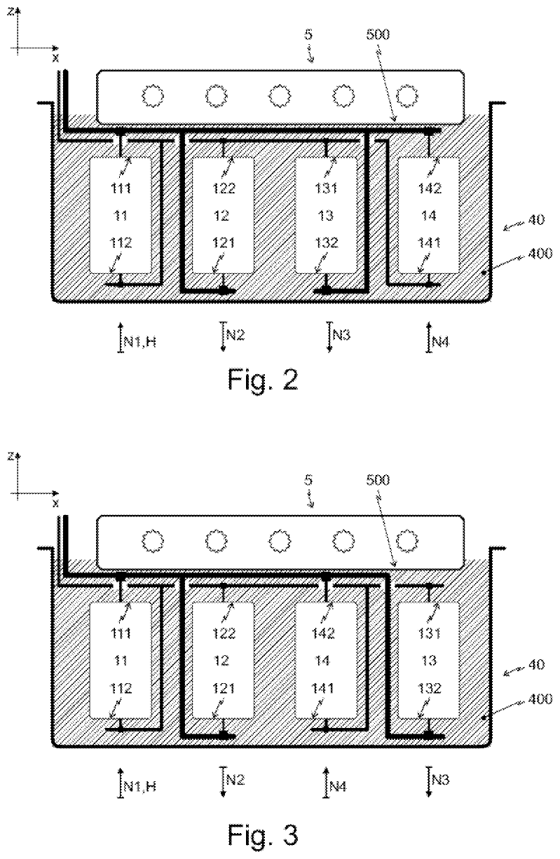

The capacitor assembly 1 here has, cf FIG. 2, a first to fourth individual capacitor 11, 12, 13, 14. Each individual capacitor has a first cover surface 111, 121, 131, 141 defining a respective normal direction N1, N2, N3, N4 of the individual capacitor, and a second cover surface 112, 122, 132, 142 situated opposite the first cover surface 111, 121, 131, 141, wherein the first cover surface 111 of the first individual capacitor 11 defines the main direction H. The individual capacitors 11, 12, 13, 14 of the capacitor assembly 1 each have first connection elements 113, 123, 133, 143 arranged on the associated first cover surface 111, 121, 131, 141, and each have second connection elements 114, 124, 134, 144 arranged on the associated second cover surface 112, 122, 132, 142. The individual capacitors 11, 12, 13, 14 are arranged next to one another in a 1×4 matrix, wherein the normals N1, N4 of the first and fourth individual capacitors 11, 14 point in the main direction H and wherein the normals N2, N3 of the second and third individual capacitors 12, 13 point in the opposite direction to the main direction H. All the first connection elements 113, 123, 133, 143 are connected to one another by means of a first busbar 30. All the second connection elements 114, 124, 134, 144 are likewise connected to one another by means of a second busbar 32.

The cooling device 5 has a first cooling contact surface 500 which is in direct thermal contact with the capacitor assembly 1. Without restricting the general nature of the invention, the thermal contact directly, i.e. separated only by the insulating layer 7, with a first and second main section 300, 320 here consists of part of a first and second busbar 30, 32. The individual capacitors 11, 12, 13, 14 are then, without restricting the general nature of the invention, in turn in indirect thermal contact with the first cooling contact surface 500 via the main sections 300, 320.

In the configuration of the busbar 30, 32, a first intermediate section 302 of the first busbar 30 and a first intermediate section 322 of the second busbar 32 are arranged between the first and second individual capacitors 11, 12, and a second intermediate section 302 of the first busbar 30 and a second intermediate section 322 of the second busbar 32 are arranged between the third and fourth individual capacitors 13, 14 so that they overlap each other and are in each case separated by a second insulating device.

A second cooling contact surface 520, situated opposite the first one, of the cooling device 5 is in direct thermal contact with the power semiconductor module 6. The latter is arranged directly on the second cooling contact surface 502. As is customary, a heat-conducting paste can also be arranged between the power semiconductor module 6 and the second cooling contact surface 520.

The power semiconductor module 6 has direct-current load connection elements 60, 62 which are connected electrically conductively with the correct polarity to associated module sections 306, 326 of the first and second busbars 30, 32.

The power semiconductor module 6 is connected to the control switching device 660 by means of auxiliary contact elements 66. This control switching device 660 takes the form of a customary printed circuit board and serves to activate the power semiconductor module 6 and receives the associated control signals via a plug connection (not illustrated) with a higher-level control system, in particular a vehicle control system, if the power electronics system is part of a drive train of an electric vehicle.

A second housing part 42 interacting with the first housing part 40 covers the cooling device 5, the power semiconductor module 6 and the control switching device 660. This second housing part 42 has openings 420 for alternating-current load connection elements 64 and also the plug connections (not illustrated) for control signals.

FIG. 2 shows a side view of a first embodiment of a capacitor assembly 1 according to the invention arranged in the first housing part 40. The latter is filled with an insulating compound 400 which covers the whole capacitor assembly 1 as well as the main sections 300, 320 of the busbars 30, 32. In addition, another section, facing the capacitor assembly 1, of the cooling device 5 is embedded in the insulating compound 400.

The individual capacitors 11, 12, 13, 14 are here arranged in the sequence of a first, second, third and fourth individual capacitor 11, 12, 13, 14 and have the illustrated normals N1, N2, N3, N4, wherein the normals N1, N4 of the first and fourth individual capacitors 11, 14 are oriented in the main direction H, whilst the normals N2, N3 of the second and third individual capacitors 12, 13 are oriented in an opposite direction to the main direction H.

FIG. 3 shows a side view of a second embodiment of a capacitor assembly 1 according to the invention. In contrast to the first embodiment according to FIG. 2, the individual capacitors 11, 12, 13, 14 are here arranged in the sequence of a first, second, fourth and third individual capacitor 11, 12, 14, 13 and the illustrated normals N1, N2, N3, N4 have the orientations mentioned for FIG. 2.

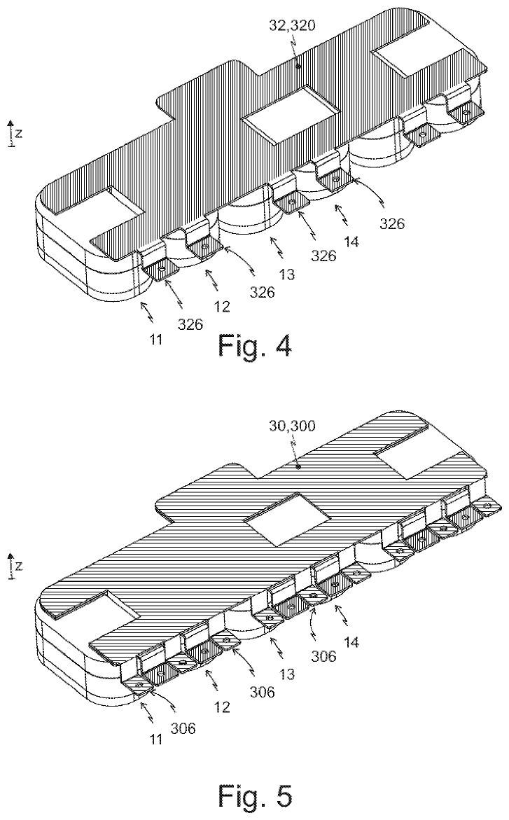

FIGS. 4 and 5 show the busbars 30, 32 of a first embodiment, cf FIG. 2, of a capacitor assembly 1 according to the invention in a three-dimensional view seen from the direction of the cooling device 5, cf FIG. 1. Illustrated here is a capacitor assembly 1 in the form of a 1×6 matrix which contains the capacitor assembly 1 according to the invention in the form of a 1×4 matrix with a first to fourth individual capacitor 11, 12, 13, 14. This capacitor assembly 1 is illustrated in FIG. 4 with the second busbar 32 but without the first busbar 30. The first busbar 30 is then also illustrated additionally in FIG. 5. The remainder of the embodiment corresponds fundamentally to that in FIG. 2.

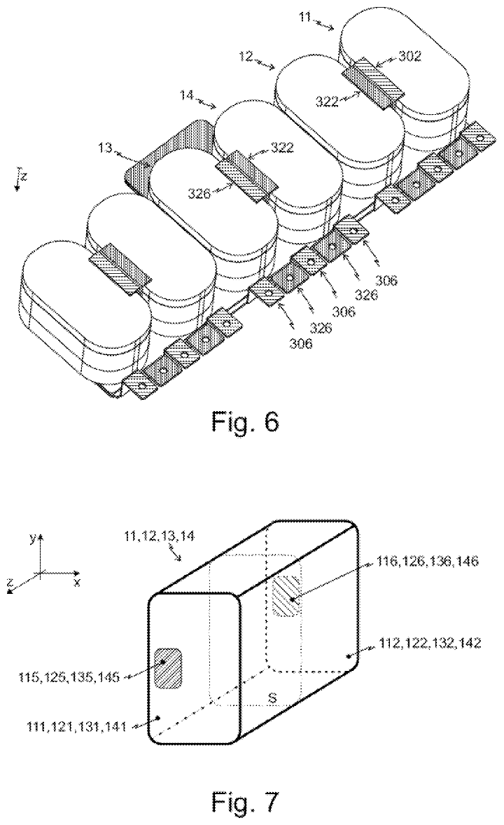

FIG. 6 shows a three-dimensional view of a second embodiment, cf FIG. 3, of a capacitor assembly 1 according to the invention in a three-dimensional view seen from the direction of the cooling device 5, cf FIG. 1. Illustrated here is a capacitor assembly 1 in the form of a 1×6 matrix which contains the capacitor assembly 1 according to the invention in the form of a 1×4 matrix with a first to fourth individual capacitor 11, 12, 13, 14. The remainder of the embodiment corresponds fundamentally to that in FIG. 3.

FIG. 7 shows an individual capacitor 11, 12, 13, 14 of a capacitor assembly 1 and the position of a plane of symmetry or a cut surface of the first surface section 115, 125, 135, 145 on the first cover surface 111, 121, 131, 141 with respect to the second surface section 116, 126, 136, 146 on the second cover surface 112, 122, 132, 142, in the case of a substantially cuboid embodiment of the individual capacitor 11, 12, 13, 14.

While the present disclosure has been illustrated and described and with respect to a particular embodiment thereof, it should be appreciated by those of ordinary skill in the art that various modifications to this disclosure may be made without departing from the spirit and scope of the present disclosure.

What is claimed is:

1. A capacitor assembly with a first to fourth individual capacitor each with a first cover surface defining a respective normal direction of the individual capacitor, and a second cover surface situated opposite, wherein the first cover surface of the first individual capacitor defines a main direction (H), with in each case first connection elements arranged on the first cover surface and in each case second connection elements arranged on the second cover surface, wherein the individual capacitors are arranged next to one another in a 1×4 matrix, wherein the normals of the first and third individual capacitors point in the main direction (H) and wherein the normals of the second and fourth individual capacitors point in the opposite direction to the main direction (H) and wherein all the first connection elements are connected to one another by means of a first busbar and wherein all the second connection elements are connected to one another by means of a second busbar.

2. The capacitor assembly according to claim 1, wherein the individual capacitors are arranged in the sequence of a first, second, third and fourth individual capacitor or in the sequence of a first, second, fourth and third individual capacitor.

3. The capacitor assembly according to claim 1, wherein
the in each case first connection elements of all the individual capacitors are arranged in a first surface section of the first cover surface, and the in each case second connection elements of all the individual capacitors are arranged in a second surface section of the second cover surface.

4. The capacitor assembly according to claim 3, wherein,
in each case the first surface section and second surface section of an individual capacitor are arranged symmetrically with respect to each other.

5. The capacitor assembly according to claim 4, wherein,
the symmetry is point symmetry with respect to the centre point of the individual capacitor or mirror symmetry with respect to a cut surface of the individual capacitor.

6. The capacitor assembly according to claim 1, wherein
the first and second busbars are formed as flat metal mouldings.

7. The capacitor assembly according to claim 6, wherein,
the first and second busbars are arranged so that they overlap each other in sections and are separated by a first insulating device.

8. The capacitor assembly according to claim 1, wherein
a first intermediate section of the first busbar and a first intermediate section of the second busbar are arranged between the first and second individual capacitors and a second intermediate section of the first busbar and a second intermediate section of the second busbar are arranged between the third and fourth individual capacitors so that they overlap each other and are in each case separated by a second insulating device.

9. The capacitor assembly according to claim 1, wherein
the first busbar has an additional first connection section and the second busbar has an additional second connection section which are arranged so that they overlap each other in one section and these connection sections are designed to simultaneously supply energy to all the individual capacitors.

10. The capacitor assembly according to claim 1, wherein
the first busbar has additional first module sections and the second busbar has additional second module sections and these module sections are designed to simultaneously supply energy to the power semiconductor modules from the individual capacitors.

11. The capacitor assembly according to claim 1, wherein
the respective contact sections of the busbars with the associated connection elements of the individual capacitors are materially bonded, preferably welded, to one another.
